(19) United States
(12) Patent Application Publication
(10) Pub. No.: US 2008/0212455 A1
(43) Pub. Date: Sep. 4, 2008

(54) Method of Enhancing Laser Operating Efficiency

(75) Inventor: Pieter Hoeven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,171

(22) PCT Filed: May 17, 2005
(86) PCT No.: PCT/IB05/51592

§ 371 Date: Nov. 16, 2006

(30) Foreign Application Priority Data
May 25, 2004 (EP) 04102283.1

(51) Int. Cl. G11B 7/00

(52) U.S. Cl. 369/121

(57) ABSTRACT

A method of enhancing laser operating efficiency of a laser (50) for use in an optical data read and/or write device (10) is described. The method is distinguished in that it includes steps of: a) generating a pulse excitation signal having one or more sequences of pulses whose pulse frequency is substantially in a range of 50 MHz 250 MHz; and b) arranging for the one or more sequences of pulses to modulate excitation current through the laser (50), the pulses traversing a lasing threshold of the laser (50). The method is of benefit in that it is capable of enhancing operating efficiency of the laser (50), thereby either enabling the laser to be driven to generate more optical output or for reducing temperature rise occurring in the laser (50) when in operation.

The present invention relates to methods of enhancing laser operating efficiency, for example for use in reducing operating temperatures of lasers in optical data read/write devices and/or increasing optical output power from such devices. Moreover, the invention also relates to lasers arranged to operate according to the methods. Furthermore, the invention relates to data memory apparatus including such lasers operating according to the methods.

It is generally known that lasers are employed in optical data memory read/write drives such as compact disk (CD) drives and digital video disk (DVD) drives; such drives are often employed in contemporary consumer products such as audio systems, disk video recorders and personal computers (PC's). Moreover, it is also generally known that considerably more laser power is required when writing data to data carriers in such CD and DVD drives in comparison to reading data from these carriers.

Adapting laser power in response to executing data writing and data reading operations is known. For example, in a published European patent application no. EP 1, 162,611, there is described a method of controlling laser diodes in optical disk players. In the published application, electrical power consumed by a laser diode is reduced when using radiation output therefrom for reading data from an optical disk or a magneto-optical disk. The laser diode is coupled to a laser diode control circuit operable to cause the laser diode to emit continuously rather than intermittently, even if a data playback clock (PCK) signal is supplied to the laser diode control circuit, when the optical disk player or magneto-optical disk player has not yet stabilized and is being pulled into phase-locked state. When focus is locked in the circuit, the player is in a phase-locked state which causes a mode-switching circuit of the control circuit to switch the mode of operation of the laser diode from continuous operation to intermittent operation. The frequency of the aforementioned PCK signal is multiplied by a frequency multiplying circuit to generate a corresponding high frequency signal whose pulse width is pulse-width adjustable for modulating current provided to the laser diode. Thus, higher laser power is employed until pull-in occurs after which laser diode current is decreased to reduce power dissipation within the laser diode.

The inventor has appreciated that although modification of laser diode current by pulse-width modulation at higher frequencies is known for performing various reading or writing functions in optical memory devices, such modification has not hitherto been applied optimally. Moreover, the inventor has also identified that, in optical recorders employing laser diodes for writing data and/or reading data from associated data carriers, for example as in CD and DVD recorders, the laser diodes are required to operate at increasingly greater powers in order to achieve more rapid data recordation and data readout rates. Power dissipation in the laser diodes of these optical recorders is especially pertinent for prolonged data recordation at elevated laser powers.

A problem encountered with increased laser diode power dissipation is elevated diode operating temperatures. Such elevated temperatures are susceptible to reducing laser diode operating lifetime by frequent thermal cycling and generation of thermally-induced defects into laser cavities of such laser diodes. Moreover, elevated laser diode operating temperatures can in certain circumstances result in spontaneous laser diode failure.

A further problem encountered with increasing laser diode power is that operating such diodes continuously at reduced excitation currents for reading purposes suffers from relatively increased output noise in radiation emitted from the laser diodes. Such increased noise can adversely affect data readout reliability on account of reduced signal-to-noise ratio, for example arising on account of optical feedback instabilities.

The inventor has appreciated that laser noise can be reduced whilst also outputting less power from a laser diode by pulse-width-modulating (PWM) excitation current to the laser diode. When digital data streams are being read out using a beam of radiation generated by the PWM laser diode, it is beneficial that the excitation current is modulated at a frequency at least twice of a rate at which the data is being read on account of Nyquist sampling considerations. It is however conventional practice to employ very high PWM frequencies in the order of 300 MHz to 500 MHz.

The inventor has appreciated that such conventional PWM control of laser diodes is non-optimal and has therefore devised a method of reducing laser operating temperature whilst also at least partially addresses the aforesaid laser diode noise problems.

Thus, it is an object of the invention to provide a method of enhancing laser operating efficiency, for example for use in reducing laser operating temperature and/or increasing laser optical output in optical memory devices. According to a first aspect of the present invention, there is provided a method of enhancing laser operating efficiency of a laser included in an optical data read and/or write device, the method characterized in that it includes steps of
a) generating a pulse excitation signal having one or more sequences of pulses whose pulse frequency is substantially in a range of 50 MHz to 250 MHz; and
b) arranging for the one or more sequences of pulses to modulate excitation current through the laser, the pulses traversing a lasing threshold of the laser.

The invention is of advantage in that it is capable of enhancing laser operating efficiency by exploiting differences in impedance characteristics exhibited by such a laser at different excitation frequencies.

Preferably, the method further comprises a step of applying optical radiation generated by the laser for one or more of: reading data from an optical data carrier, writing data to an optical data carrier. By applying the method to the laser, potentially greater speeds of data writing and/or data reading are possible in comparison to similar types of contemporary devices.

Preferably, in the method, the laser is operable to exhibit a lower electrical impedance when excited using the method at a pulse repetition frequency in a range of substantially 50 MHz to 250 MHz, in comparison to being excited at a pulse repetition frequency of substantially 400 MHz. Use of such a lower frequency range enables the laser and its associated laser driver to operate potentially more efficiently.

Preferably, in order to reduce dissipation using the method, excitation current through the laser is reduced substantially to zero between excitation pulses in the one or more sequences. Reduction of the excitation current substantially to zero is easier to implement in a frequency range of 50 MHz to 250 MHz in comparison to 400 MHz.

Preferably, in order to reduce power dissipation using the method, the excitation current between the pulses is maintained at substantially zero for a dwell period. More preferably, the dwell period is at least as long as an excitation period of each pulse during which excitation current is applied to the laser.

Preferably, in order to circumvent violation of Nyquist sampling criteria, the method is arranged so that the pulse frequency is sufficiently high to substantially circumvent aliasing when reading data from or writing data to a data carrier of the drive.

According to a second aspect of the invention, there is provided an optical pickup unit for an optical data read and/or write device, the unit including a laser for generating optical radiation for reading and/or writing data, the laser being arranged to operate according to the method of the first aspect of the invention.

According to a third aspect of the invention, there is provided an optical data read and/or write device, the device including a laser for generating optical radiation for reading and/or writing data, the laser being arranged to operate according to the method of the first aspect of the invention.

According to a fourth aspect of the invention, there is provided software for use in controlling operation of an optical data read and/or write device including a laser for generating optical radiation for reading and/or writing data, the software being executable on one or more computing devices for implementing the method according to the first aspect of the invention.

According to a fifth aspect of the invention, there is provided a data processing unit for use in an optical data read and/or write device including a laser for generating optical radiation for reading and/or writing data, the processing unit being configured to execute the method according to the first aspect of the invention.

According to a sixth aspect of the invention, there is provided a laser for use in an optical data read and/or write device, the laser being operable according to the method of the first aspect of the invention.

It will be appreciated that features of the invention are susceptible to being combined in any combination without departing from the scope of the invention.

Embodiments of the invention will now be described, by way of example only, with reference to the following diagrams wherein:

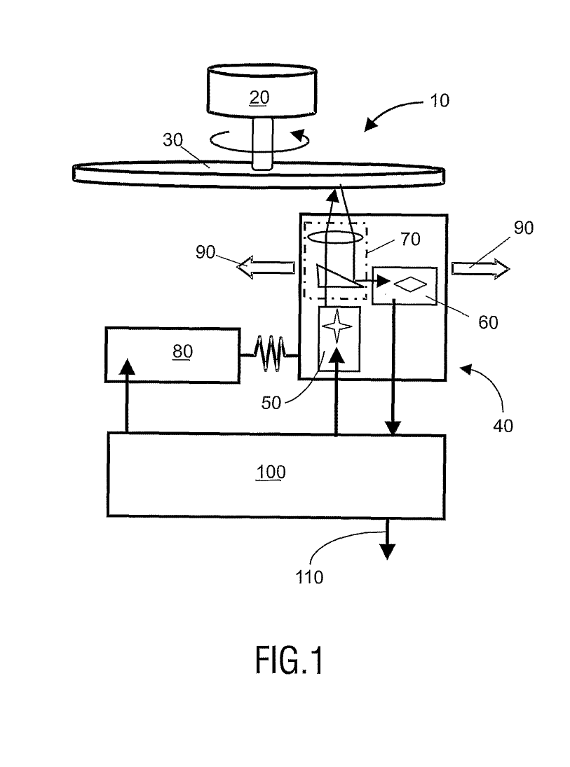

FIG. 1 is a schematic diagram of an optical memory device including an optical data carrier, an optical pickup unit (OPU) including a laser diode and an optical sensor, together with an actuator device for moving the pickup unit relative to the data carrier;

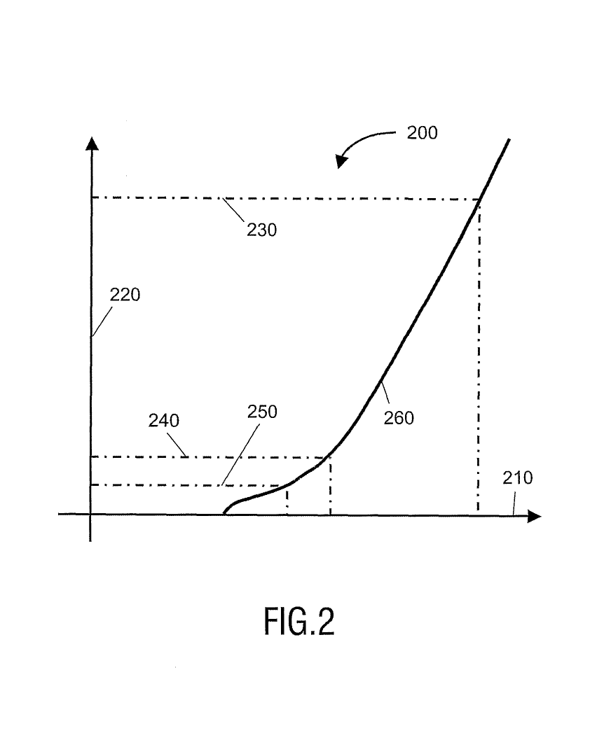

FIG. 2 is a graph of lasing characteristics of the laser diode of FIG. 1;

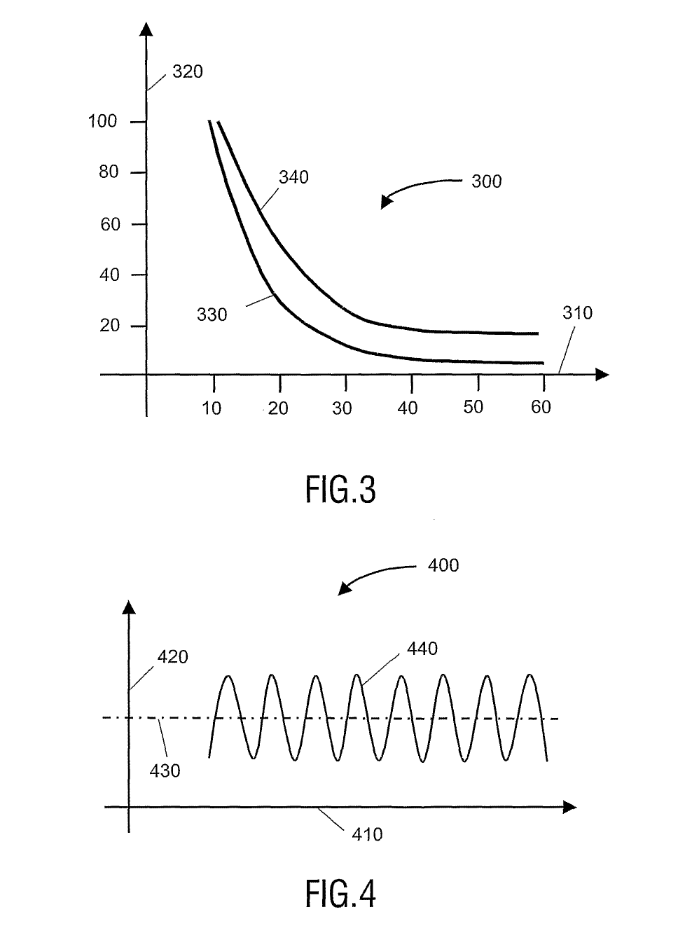

FIG. 3 is a schematic graph of a relative impedance characteristic of the laser diode of the memory device of FIG. 1;

FIG. 4 is a graph illustrating a modulated excitation current relative to threshold current applied to the laser diode of FIG. 1;

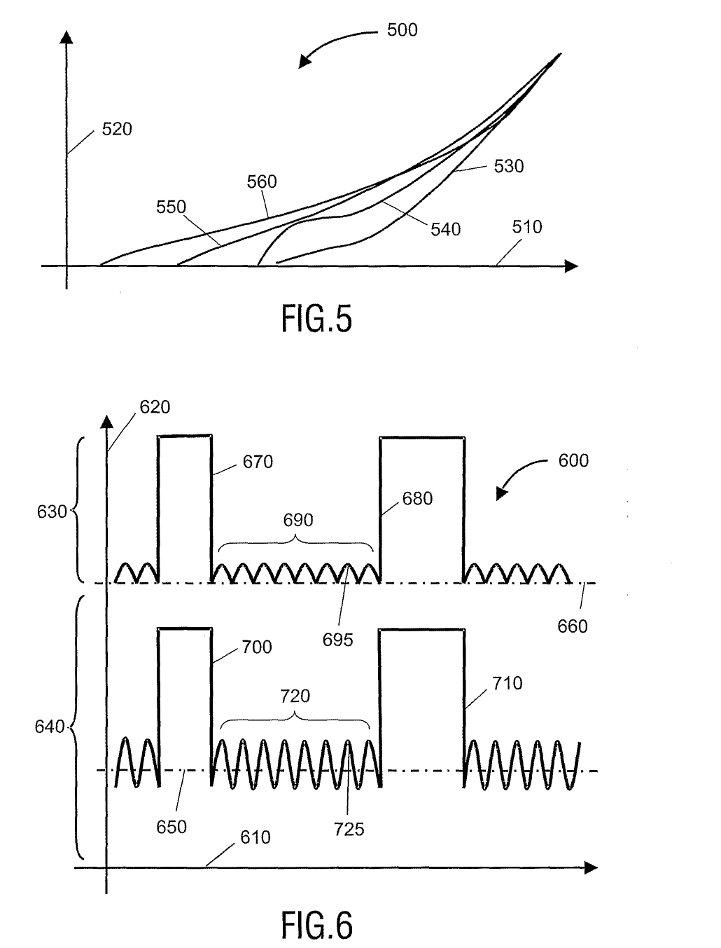

FIG. 5 is a graph of optical output power of the laser diode of FIG. 1 plotted against diode excitation current for various laser diode excitation current modulation conditions;

FIG. 6 is a first graph of optical output from the laser diode of FIG. 1 as a function of excitation current supplied to the laser diode in operation, the diode being arranged to operate in a conventional mode; and

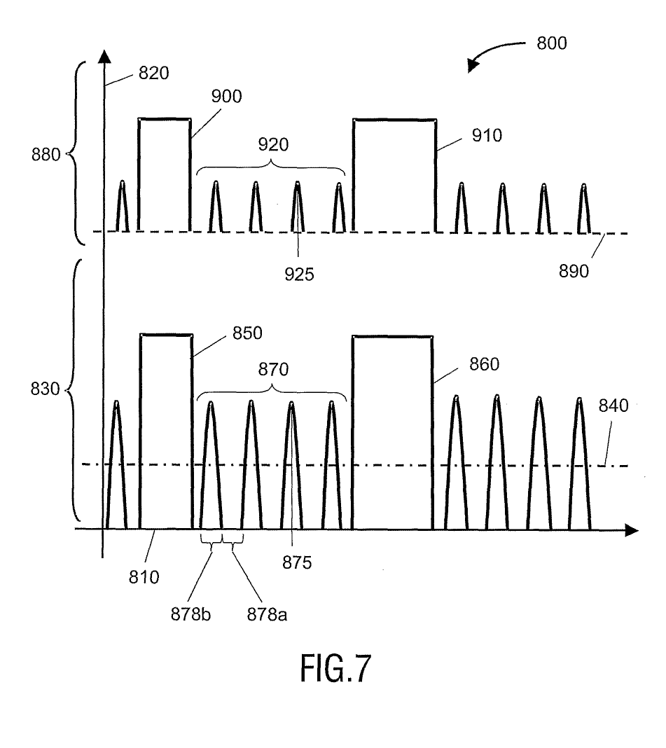

FIG. 7 is a second graph of optical output from the laser diode of FIG. 1 as a function of excitation current supplied to the laser diode in operation, the diode being arranged to operate in a mode according to the invention.

Embodiments of the invention will be described with reference to the accompany diagrams, wherein FIG. 1 is a schematic illustration of an optical memory device indicated generally by 10. The memory device 10 is, for example, capable of forming the basis of a CD read/write apparatus, a DVD read/write apparatus, and an optical memory for a personal computer; other potential applications for the device 10 are also feasible.

The device 10 comprises a drive motor 20 and associated components for engaging an optical disk data carrier 30. The motor 20 is operable to rotate the carrier 30 relative to an optical pickup unit (OPU) indicated generally by 40. The unit 40 comprises a laser diode 50 for generating a beam of interrogating radiation which is focused via an optical assembly 70 to generate in operation a finely focused spot of radiation on a data-carrying surface of the carrier 30. The pickup unit (OPU) 40 is also arranged to receive reflected and back-scattered return radiation from the data-carrying surface, this return radiation being arranged to propagate via the optical assembly 70 to an optical sensor 60. The sensor 60 in turn generates a signal conveying a data stream which is passed out for processing. The pickup unit 40 is mechanically coupled to an actuating unit 80 which is operable to move the unit 40 laterally in directions denoted by arrows 90 relative to the carrier 30 for selecting preferred regions of the carrier 30. The device 10 further includes a processing control unit 100 for controlling operation of the device 10, for example for processing data in preparation for writing onto the carrier 30 and/or for processing data read from the carrier 30 via the sensor 60, for example to generate an output data stream denoted by 110.

The device 10 is capable of operating in numerous different modes. In order to function optimally, electrical excitation applied by the control unit 100 to the laser diode 50 is either continuous or temporally intermittent, namely pulsed, as will be described later in more detail. Amongst its modes of operation, the device 10 is capable of functioning in a recording mode and in a record-pause mode; the record-pause mode corresponds to the device 10 preparing for making a recording on the data carrier 30. In the recording mode and record-pause mode, the inventor has appreciated that drive power applied to laser diode 50 can be reduced, in particular by applying pulsed excitation current to the laser 50 such that:
a) the pulsed current is applied at a lower frequency than conventionally employed to modulate laser diodes in contemporary CD or DVD read/write drives; in conjunction with
b) higher peak diode currents than conventionally employed.

The combination of (a) and (b) above has been demonstrated by the inventor to result in comparable laser diode optical output power in comparison to conventional laser diode configurations but at reduced laser diode operating temperature. Such reduction in operating temperature can also provide a thermal advantage that can be exploited to increase laser output power for a given operating temperature. Beneficially, when applying the device 10 to record data onto its data carrier 30, such recording does not involve reading RF and DPD signals, only wobble and servo signals which are less critical.

Advantages arising from utilizing a regime (a) and (b) above will now be elucidated in more detail. In FIG. 2, there is shown a graph indicated generally by 200 illustrating optical output power of the laser diode 50 as a function of its excitation current. The graph 200 comprises an abscissa axis 210 for representing excitation current increasing from left to right. Moreover, the graph 200 includes an ordinate axis 220 denoting optical output power of the laser diode 50 wherein the output power increases from bottom to top of the graph 200. An intersect of the axes 210, 220 corresponds to zero. A characteristic of the laser diode 50 is represented by a curve 260. Along the curve 260, there are shown dashed lines 230, 240, 250 such that:
a) the line 230 corresponds to optical power output from the laser diode 50 required for writing data onto the data carrier 30;
b) the line 240 corresponds to optical power output from the laser diode 50 required for reading data from the data carrier 30; and
c) the line 250 corresponds to a lasing threshold of the laser diode 50, at which optical feedback in the diode 50 is just sufficient to sustain lasing action therein.

It will be seen from FIG. 2 that the laser diode 50 is operated at considerably lower power for data reading purposes in comparison to rather higher power for data writing purposes. The line 240 is relatively close to the lasing threshold as represented by the line 250. Below the lasing threshold, operation of the laser diode 50 is noisy and potentially unreliable. However, in practice, it is desirable to optimize optical output from the laser diode 50 in respect of power dissipation arising therein for data recording purposes, and to operate the diode 50 sufficiently away from the lasing threshold so that the optical output from the laser diode 50 for reading purposes is not noisy.

The inventor has appreciated that electrical impedance characteristics of the laser diode 50 with regard to pulsed excitation current applied to the diode 50 vary as a function of the pulse frequency. Such impedance characteristics are illustrated in a graph provided in FIG. 3, the graph being indicated generally by 300. The graph 300 includes an abscissa axis 310 denoting average excitation current from 0 mA to 60 mA. Moreover, the graph 300 includes an ordinate axis 320 representing electrical impedance Z of the laser diode 50 in respect of excitation current; the ordinate axis 320 is plotted in a range of 0 ohms to 100 ohms. In the graph 300, there are included curves 330, 340 corresponding to 100 MHz and 400 MHz pulse excitation respectively. It will be appreciated from FIG. 3 that the laser diode 50 exhibits a lower impedance at 100 MHz in comparison to 400 MHz. Moreover, it will also be appreciated that conventional CD and DVD read/write devices employ laser diode pulsed excitation in the order of 400 MHz corresponding to the curve 340, whereas the device 10 employs a somewhat lower pulse frequency in a range of 50 MHz to 250 MHz corresponding to the curve 330 at 100 MHz. In a situation where the impedance Z plotted along the ordinate axis 320 is not purely reactive but includes a significant real resistive component, power dissipation in the laser diode 50 for a given average excitation current is lower at a pulse excitation frequency of 100 MHz, namely in a range of 50 MHz to 250 MHz, in comparison to a more conventional pulse excitation frequency in the order of 400 MHz. Such a reduced power dissipation at around 100 MHz in comparison to around 400 MHz persists as the pulsed excitation current is increased as shown in the graph 300. A most preferred pulsed excitation frequency for excitation current to the laser diode 50 is substantially 150 MHz, for example in a range of 120 MHz to 180 MHz.

When applying pulsed excitation to the laser diode 50, the excitation current is preferably modulated below the lasing threshold, denoted by the line 250 in FIG. 2, in a manner as illustrated in FIG. 4. In FIG. 4, there is shown a temporal graph indicated generally by 400. The graph 400 includes an abscissa axis 410 for denoting the passage of time from left to right, and an ordinate axis 420 for pulse excitation current applied to the laser diode 50 wherein the excitation current increases from bottom to top in the graph 400. A dashed line 430 corresponds to lasing threshold current, equivalent to the line 250. Thus, in order for the control unit 100 to operate the laser diode 50 in pulse mode, an excitation current as denoted by a curve 440 is preferably applied to the laser diode 50. Preferably, the curve 440 corresponds to excitation whose frequency is in a range of 50 MHz to 250 MHz, more preferably 120 MHz to 180 MHz, and most preferably substantially 150 MHz at which most power efficiency benefit is found to occur.

In order to elucidate the present invention further, reference is made to FIG. 5 in which a graph is indicated generally by 500. The graph 500 includes an abscissa axis 510 denoting excitation current applied to the laser diode 50 increasing from left to right, and also an ordinate axis 520 denoting optical output power increasing from bottom to top. An intersect of the axes 510, 520 corresponds to zero. The graph 500 includes four curves as follows:
a) a curve 530 corresponds to optical output power from the laser diode 50 when excited with non-pulsed steady d.c. current;
b) a curve 540 corresponds to optical output power from the laser diode 50 when excited with pulsed current at a frequency of 450 MHz, namely as in conventional known CD or DVD read/write devices;
c) a curve 550 corresponds to optical output power from the laser diode 50 subject to pulse excitation at a frequency of substantially 100 MHz according to the invention; and
d) a curve 560 corresponds to optical output power from the laser diode 50 subject to pulse excitation at a frequency as in (c) above but with a greater peak pulse current also according to the present invention.

It will be seen from the graph 500 that the curves 540, 550 correspond to increased optical output power from the laser diode 50 for a given average excitation current, as represented by the axis 510, and hence to greater efficiency of conversion of electrical power to optical power through the laser diode 50.

The present invention also provides benefits in that modulation of the excitation current for the laser diode 50 at relatively lower frequencies around 100 MHz is easier to achieve than at relatively higher frequencies around 450 MHz, especially at relatively lower excitation currents around 10 mA in FIG. 3 where the curve 340 corresponds to a higher impedance than the curve 330.

The present invention not only provides benefits during writing data to the data carrier 30 but also when reading data therefrom, such that the laser diode 50 is subject to pulse excitation for both read and write functions.

Referring to FIG. 6, there is shown a graph indicated generally by 600. The graph 600 comprises an abscissa axis 610 corresponding to passage of time from left to right. Moreover, the graph 600 also comprises an ordinate axis 620 corresponding in a region 640 thereof to pulsed excitation current applied to the laser diode 50, and in a region 630 thereof to optical output power from the laser diode 50. A line 650 relates to excitation current corresponding to the aforementioned lasing threshold, namely to lines 250, 430. Moreover, a line 660 corresponds to substantially zero optical output from the laser diode 50. Optical pulses 670, 680 correspond to periods where the laser diode 50 is operated at full power, for example when implementing specific recording or searching functions; the optical pulses 670, 680 correspond to excitation current pulses 700, 710 respectively. Moreover, a series of optical pulses denoted by 690, for example including an optical pulse 695, corresponds to pulsed excitation current as represented by 720, for example an excitation current pulse 725 corresponds to the optical pulse 695. It will be seen that the pulsed excitation current 720 is modulated at a region substantially around the lasing threshold line 650. Moreover, it will be appreciated from the graph 600 that the region 690 corresponds to relatively inefficient operation of the laser diode 50. The graph 600 presents a more conventional operating regime for the laser diode 50 where the regions 690, 720 corresponds to excitation at a frequency in the order of 400 MHz.

In contrast to FIG. 6, the laser diode 50 is capable of being operated in a manner as represented by the curves 540, 550 in FIG. 5 in order to increase operating efficiency of the laser diode 50. In order to elucidate such a manner of operation, reference is now made to FIG. 7 wherein a graph is indicated generally by 800. The graph 800 includes an abscissa axis 810 for representing passage of time from left to right. Moreover, the graph 800 includes an ordinate axis 820 corresponding in a region 830 to excitation current applied to the laser diode 50, and in a region 880 to optical output power from the laser diode 50. In the region 830, the abscissa axis 810 corresponds to zero current to the laser diode 50. Moreover, a line 840 corresponds to the lasing threshold of the laser diode 50, namely in a similar manner to the lines 250, 430, 650. Peaks 850, 860 represent peak excitation current applied to the laser diode 50, and are to be compared temporally with the peaks 700, 710 in FIG. 6. In a region 870 between the peaks 850, 860, there is shown a series of current pulses, for example a current pulse 875.

In the region 880, zero optical output power from the laser diode 50 corresponds to a dashed line 890. Optical output peaks 900, 910 correspond to the current peaks 850, 860 respectively. Moreover, optical peaks in a region denoted by 920 between the peaks 900, 910 correspond to the current peaks in the region 870.

When comparing FIGS. 6 and 7, some important differences are to be noted which assist in distinguishing FIG. 7 representing the present invention from FIG. 6 which represents prior art. In FIG. 6, excitation current supplied to the laser diode 50 is not switched substantially to zero on account of difficulties when pulse exciting the laser diode 50 at pulse excitation frequencies in the order of 400 MHz, for example during the region 720; in contrast, in FIG. 7, the excitation current can be reduced to zero between pulses in the region 870 when operating at pulse excitation frequencies in the order of 100 MHz. Moreover, between the pulses in the region 870 are periods, for example a dwell time 878a in which excitation current through the laser diode 50 is substantially zero; preferably, the dwell time 878a is at least as long as its neighboring excitation period 878b. Optical output pulses in the region 920 in FIG. 7 are of greater magnitude than the optical pulses in the region 690 of FIG. 6; however, the average optical power generated in the region 920 is similar to that generated in the region 690, although the region 920 involves less dissipation in the laser diode 50 in comparison to the region 690.

The pulses 670, 680, 900, 910 preferably correspond to optical write pulses for writing data onto the data carrier 30, whereas the regions 690, 920 correspond to read data illumination for reading data from the data carrier 30.

Thus, by a combination of reducing laser excitation current frequency from substantially 400 MHz to 100 MHz combined with increasing the magnitude of peak pulse current applied to the laser diode 50, it is feasible to increase conversion efficiency of electrical power to optical power in the laser diode 50 when used in devices such as CD or DVD read/write drives.

Whereas conventional practice is to employ substantially as high a pulse modulation frequency as possible when energizing a laser diode in an optical data carrier read/write device, for example to frequencies approaching 1 GHz, the present invention utilizes an operating regime wherein the current excitation applied to the laser diode 50 is sufficiently high to avoid aliasing effects when reading and/or writing data to the data carrier 30 but sufficiently low for the excitation current to be of greater modulation depth in comparison to contemporary approaches to exciting laser diodes. Gains in operating efficiency thereby derived can either be used to lower temperature rise occurring in the laser diode 50 during operation, or be used the increase optical output from the laser diode 50 for a given operating temperature; increased optical output is of potential benefit when reading data from, or writing data to, the optical data carrier 30 at enhanced speeds.

It will be appreciated that embodiments of the invention described in the foregoing are susceptible to being modified without departing from the scope of the invention as defined by the accompanying claims.

Symbols included within brackets in the accompanying claims are intended to assist understanding of the claims and are not intended in any way to limit the scope of the claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of enhancing laser operating efficiency of a laser (50) for use in an optical data read and/or write device (10), the method characterized in that it includes steps of:
a) generating a pulse excitation signal having one or more sequences (690, 720) of pulses whose pulse frequency is substantially in a range of 50 MHz to 250 MHz; and
b) arranging for the one or more sequences (690, 720) of pulses to modulate excitation current through the laser (50), the pulses traversing a lasing threshold (650) of the laser (50).

2. A method according to claim 1, wherein the method further comprises a step of applying optical radiation generated by the laser (50) for one or more of: reading data from an optical data carrier (30), writing data to an optical data carrier (30).

3. A method according to claim 1, wherein the laser (50) is operable to exhibit a lower electrical impedance when excited using the method at a pulse repetition frequency in a range of substantially 50 MHz to 250 MHz, in comparison to being excited at a pulse repetition frequency of substantially 400 MHz.

4. A method according to claim 1, wherein excitation current through the laser (50) is reduced substantially to zero between excitation pulses (725) in the one or more sequences (690, 720).

5. A method according to claim 4, wherein the excitation current between the pulses is maintained at substantially zero for a dwell period (878a).

6. A method according to claim 5, wherein the dwell period (878a) is at least as long as an excitation period (878b) of each pulse (875) during which excitation current is applied to the laser (50).

7. A method according to claim 1, wherein the pulse frequency is sufficiently high to substantially circumvent aliasing when reading data from or writing data to a data carrier of the drive (10).

8. An optical pickup unit (40) for an optical data read and/or write device (10), the unit (40) including a laser (50) for generating optical radiation for reading and/or writing data, the laser (50) arranged to operate according to the method of claim 1.

9. An optical data read and/or write device (10), the device (10) including a laser for generating optical radiation for reading and/or writing data, the laser (50) being arranged to operate according to the method of claim 1.

10. Software for use in controlling operation of an optical data read and/or write device (10) including a laser (50) for generating optical radiation for reading and/or writing data, the software being executable on one or more computing devices (100) for implementing the method according to claim 1.

11. A data processing unit (100) for use in an optical data read and/or write device (10) including a laser (50) for generating optical radiation for reading and/or writing data, the processing unit (100) being configured to execute the method according to claim 1.

12. A laser (50) for use in an optical data read and/or write device (50), the laser (50) being operable according to the method of claim 1.
